(19) United States
(12) Patent Application Publication
(10) Pub. No.: US 2023/0069378 A1
(43) Pub. Date: Mar. 2, 2023

(54) OPTIMIZED CORE PARTICLES FOR OPTICAL FIBER PREFORM AND OPTICAL FIBER PREFORM THEREOF

(71) Applicant: Sterlite Technologies Limited, Gurgaon (IN)

(72) Inventors: Nivedita Prasad, Gurgaon (IN); Chandan Saha, Gurgaon (IN)

(21) Appl. No.: 17/553,133

(22) Filed: Dec. 16, 2021

(30) Foreign Application Priority Data
Aug. 27, 2021 (EP) 20748402.3

(51) Int. Cl. C03B 37/012; C03B 37/027; C03C 13/04

(52) U.S. Cl. CPC C03B 37/01282; C03B 37/02763; C03B 37/01205; C03C 13/046; C03B 2201/12; C03C 2213/00

(57) ABSTRACT

A method for manufacturing of an optical fibre preform (100) using optimized core particles includes optimization of particles of calcium aluminum silicate powder (104), utilizing the optimized core particles, sintering the optimized core particles inside a fluorine doped glass tube (106) and drawing of an optical fibre. Particularly, the optimization of the particles of calcium aluminum silicate powder (104) facilitates formation of the optimized core particles and the optimized core particles are filled inside the fluorine doped glass tube (106). Moreover, sintering of the optimized core particles solidifies and adheres smoothly with the fluorine doped glass tube (106) for manufacturing of the optical fibre preform (100).

### FIELD OF THE INVENTION

Embodiments of the present invention relate to the field of optical communication technology. And more particularly, relates to optimization of core particles for optical fibre preform.

### BACKGROUND

Over the last few years, there has been an exponential rise in manufacturing of optical fibres due to an overgrowing demand of the optical fibres in various sectors. The manufacturing of optical fibres has two major stages. The first stage involves the manufacturing of optical fibre preforms and the second stage involves drawing the optical fibres from the optical fibre preforms. In general, quality of optical fibres depends on conditions of manufacturing and quality of optical fibre preform. So, a lot of attention is paid towards the manufacturing of the optical fibre preforms. These optical fibre preforms include an inner glass core surrounded by one or more glass cladding layers having a lower index of refraction than the inner glass core.

The optical fibre preform is manufactured by a plurality of manufacturing methods. The plurality of manufacturing methods includes sintering of powder of core material inside cladding cylinder. The sintering of particles of core material is carried out without considering the size of particles of core material. The particle size plays an important role in sintering.

The negligence in optimizing size of particles of core material leads to improper sintering of core material. The improper sintering leads to attenuation and transmission losses in optical fibres.

Typically, the preform is manufactured by utilizing a substrate rod and a plurality of burners positioned below the substrate rod. The plurality of burners traverse along a length of the rotating substrate rod or the substrate rod rotates and traverses back and forth on top of the plurality of burners or both may traverse relatively to each other.

The presently available techniques for the production of the optical fibre preform have certain drawbacks. One of the most consistent problems which occur during the production process is the formation of undulations along the length of the optical fibre preform. The undulations are formed during the deposition process. And these undulations correspond to places of non-uniform deposition or places of alternating excess and meagre deposition.

Another problem associated with production of the optical fibre preform is the high manufacturing cost of optical fibre preforms due to manufacturing of multiple cladding layers. The multiple cladding layers increases the manufacturing cost as well as manufacturing time of the optical fibre preforms. Another problem is the large diameter of the optical fibre preforms. The large diameter of the optical fibre preform is also due the multiple cladding layers.

Thus, in light of the above stated discussion, there is a need to develop an optical fibre preform that overcomes the above stated disadvantages of the prior art.

### SUMMARY OF THE INVENTION

Embodiments of the present invention relates to a method for manufacturing of an optical fibre preform using an optimized core particles comprising steps of optimization of particles of calcium aluminum silicate powder, utilizing the optimized core particles, sintering the optimized core particles inside the fluorine doped glass tube and drawing an optical fibre. In particular, the optimization of the particles of calcium aluminum silicate powder facilitates formation of the optimized core particles. Moreover, the optimized core particles inside the fluorine doped glass tube facilitates manufacturing of the optical fibre preform. Furthermore, sintering solidifies the optimized core particles and adheres smoothly with the fluorine doped glass tube for manufacturing of the optical fibre preform. Subsequently, the optical fibre is drawn by pulling the optical fibre preform.

In accordance with an embodiment of the present invention, the particles of calcium aluminum silicate powder forms a core section of the optical fibre preform.

In accordance with an embodiment of the present invention, the core section is characterized by low attenuation of about 0.1 decibel per kilometer.

In accordance with an embodiment of the present invention, the fluorine doped glass tube forms a cladding section of the optical fibre preform. In particular, the fluorine doped glass tube has low viscosity.

In accordance with an embodiment of the present invention, the optical fibre preform is manufactured by using powder-in-cylinder technique.

In accordance with an embodiment of the present invention, the powder-in-cylinder technique facilitates the optical fibre preform to form a plurality of solid preform rods of small diameter.

In accordance with an embodiment of the present invention, sintering of the fluorine doped glass tube with the optimized core particles is performed at a temperature in the range of about 1500 degree Celsius to 1600 degree Celsius.

In accordance with an embodiment of the present invention, the optimized core particles enables drawing of the optical fibre from the optical fibre preform with low transmission loss.

Another embodiment of the present invention relates to an optical fibre preform using optimized core particles comprising a core section defined along a longitudinal axis, and a cladding section circumferentially surrounding the core section. Particularly, the cladding section is formed by a fluorine doped glass tube.

In accordance with an embodiment of the present invention, a refractive index of the core section is greater than the refractive index of cladding section.

In accordance with an embodiment of the present invention, the optimization of the particles of calcium aluminum silicate powder facilitates formation of the optimized core particles. And, the optimized core particles have size in the range of about 30 microns to 50 microns.

The foregoing objectives of the present invention are attained by employing an optical fibre preform with the optimized core particles with proper sintering of the optimized core particles during manufacturing to provide the optical fibre preform with reduced losses.

### BRIEF DESCRIPTION OF THE DRAWINGS

So that the manner in which the above recited features of the present invention is understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1A is a pictorial representation illustrating a cross-sectional view of an optical fibre preform in accordance with an embodiment of the present invention;

FIG. 1B is a block diagram illustrating the optical fibre preform in accordance with an embodiment of the present invention;

FIG. 2 is a flow chart illustrating a method of manufacturing the optical fibre preform in accordance with an embodiment of the present invention.

### ELEMENT LIST

Optical fibre preform —100
Longitudinal axis —102
Calcium aluminum silicate powder —104
Fluorine doped glass tube —106

The method and optical fibre preform are illustrated in the accompanying drawings, throughout which like reference letters indicate corresponding parts in the various figures.

It should be noted that the accompanying figure is intended to present illustrations of exemplary embodiments of the present invention. This figure is not intended to limit the scope of the present invention. It should also be noted that the accompanying figure is not necessarily drawn to scale.

### DETAILED DESCRIPTION OF THE INVENTION

The present invention relates to a reduced diameter optical fibre preform and a method of manufacturing thereof.

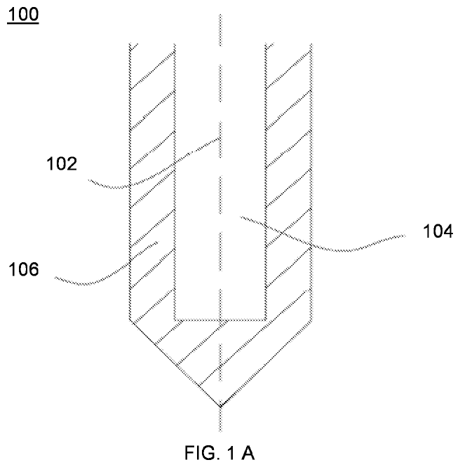

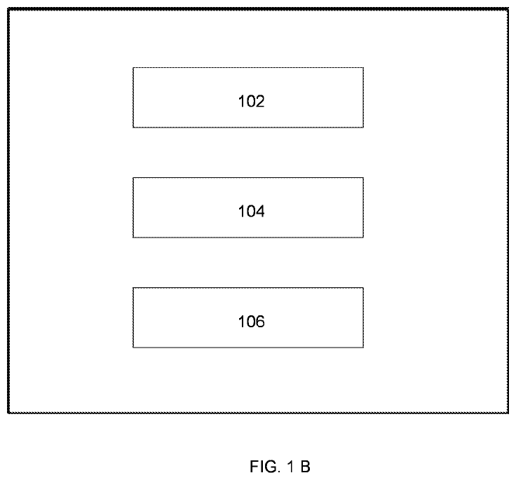

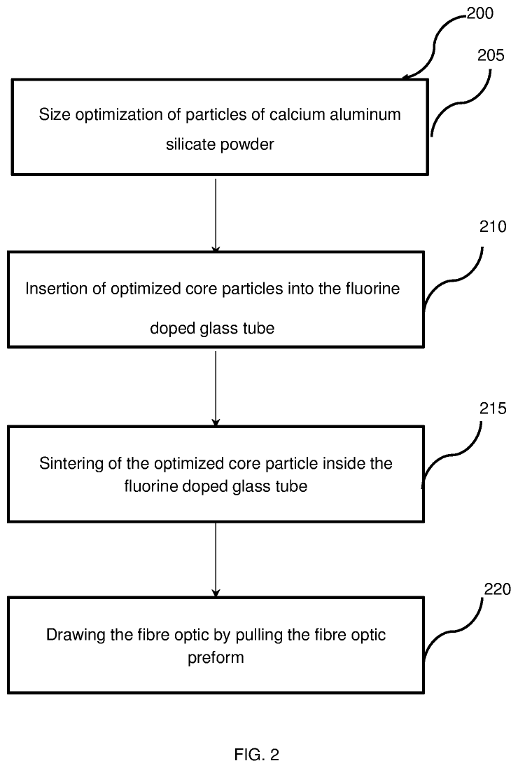

The principles of the present invention and their advantages are best understood by referring to FIG. 1A to FIG. 2. In the following detailed description numerous specific details are set forth in order to provide a thorough understanding of the embodiment of invention as illustrative or exemplary embodiments of the invention, specific embodiments in which the invention may be practiced are described in sufficient detail to enable those skilled in the art to practice the disclosed embodiments. However, it will be obvious to a person skilled in the art that the embodiments of the invention may be practiced with or without these specific details. In other instances, well known methods, procedures and components have not been described in detail so as not to unnecessarily obscure aspects of the embodiments of the invention.

The following detailed description is, therefore, not to be taken in a limiting sense, and the scope of the present invention is defined by the appended claims and equivalents thereof. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. References within the specification to “one embodiment,” “an embodiment,” “embodiments,” or “one or more embodiments” are intended to indicate that a particular feature, structure, or characteristic described in connection with the embodiment is included in at least one embodiment of the present invention.

Although the terms first, second, etc. may be used herein to describe various elements, these elements should not be limited by these terms. These terms are generally only used to distinguish one element from another and do not denote any order, ranking, quantity, or importance, but rather are used to distinguish one element from another. Further, the terms “a” and “an” herein do not denote a limitation of quantity, but rather denote the presence of at least one of the referenced items.

Conditional language used herein, such as, among others, “can,” “may,” “might,” “may,” “e.g.,” and the like, unless specifically stated otherwise, or otherwise understood within the context as used, is generally intended to convey that certain embodiments include, while other embodiments do not include, certain features, elements and/or steps.

Disjunctive language such as the phrase “at least one of X, Y, Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

### The Following Brief Definition of Terms Shall Apply Throughout the Present Invention

Optical fibre is used for transmitting information as light pulses from one end to another. In addition, optical fibre is a thin strand of glass or plastic capable of transmitting optical signals. Further, optical fibre allows transmission of information in the form of optical signals over long distances. Furthermore, optical fibre is used for a variety of purposes. The variety of purposes includes telecommunications, broadband communications, medical applications, military applications and the like.

Refractive index of a material is the ratio of speed of light in vacuum to speed of light in material.

Density of a material is the mass of a substance per unit volume of substance.

Viscosity of a fluid is fluid's resistance to gradual deformation by shear stress or tensile stress.

Sintering is a process of compacting and forming solid mass of material by heat or pressure without melting it to the point of liquefaction.

Referring to FIGS. 1A and 1B, illustrating an optical fibre preform 100, in accordance with an embodiment of the present invention. In particular, optical fibre preform is a glass body used to draw an optical fibre. The optical fibre is manufactured by initially manufacturing the optical fibre preform 100. Moreover, the optical fibre preform 100 is drawn or pulled to form the optical fibre. The optical fibre preform 100 is a cylindrical body of glass.

In particular, optical fibre preform 100 includes core structure and cladding structure. The optical fibre preform 100 is associated with a longitudinal axis 102. Moreover, the longitudinal axis 102 is an imaginary axis passing through the geometrical center of the optical fibre preform 100. Further, the optical fibre preform 100 includes particles of calcium aluminum silicate powder 104 and a fluorine doped glass tube 106. Subsequently, the particles of calcium aluminum silicate powder 104 forms a core section of the optical fibre preform 100. And, the fluorine doped glass tube 106 forms a cladding section of the optical fibre preform 100. Further, the core section is an inner part and the cladding section is an outer part of the optical fibre preform 100.

In accordance with an embodiment of the present invention, the core section is defined as a region around the longitudinal axis 102 of the optical fibre preform 100. Particularly, the core section extends radially outward from the longitudinal axis 102 of the optical fibre preform 100. Moreover, the cladding section circumferentially surrounds the core section of the optical fibre preform 100. Further, the core section has a refractive index that is greater than the refractive index of the cladding section. And, the refractive index is maintained as per a desired level based on a concentration of chemicals used for the production of the optical fibre preform 100. Subsequently, the core section and the cladding section are formed during the manufacturing stage of the optical fibre preform 100.

In accordance with an embodiment of the present invention, the core section of the optical fibre preform 100 is formed of the particles of calcium aluminum silicate powder 104. Alternatively, the core section is formed of any suitable material of the like. In general, calcium aluminum silicate powder can be obtained in various forms such as melt, glass or powder that can be casted as glass or can directly be used for making core and clad of optical fibre.

In accordance with an embodiment of the present invention, the particles of calcium aluminum silicate powder 104 are optimized to produce optimized core particles. The core section is characterized by the size of the optimized core particles. Particularly, the size of the optimized core particles is in the range of about 30 microns to 50 microns. Alternatively, the range of the size of the optimized core particles may vary. The core section is characterized by attenuation. Moreover, the attenuation of the core section is about 0.1 decibel per kilometer. Alternatively, the attenuation of the core section may vary.

In accordance with an embodiment of the present invention, the cladding section is formed of the fluorine doped glass tube 106. Alternatively, the cladding section is formed of any suitable material of the like. In particular, the optimized core particles are placed inside the fluorine doped glass tube 106. The fluorine doped glass tube 106 is characterized by lower viscosity as compared to non-doped glass.

In accordance with an embodiment of the present invention, the optical fibre preform 100 is used for manufacturing multimode optical fibre. The optical fibre preform 100 has a specific design. The specific design of optical fibre preform 100 is obtained by unique selection of materials and manufacturing process. In addition, the optical fibre preform 100 enables drawing of the optical fibre with low transmissions losses. Further, the optical fibre preform 100 is characterized by lower manufacturing cost and enables drawing of the optical fibre having low attenuation.

FIG. 2 is a flow chart illustrating a method of manufacturing the optical fibre preform in accordance with an embodiment of the present invention.

Method 200 starts at step 205, proceeds to step 210, 215 and 220.

At step 205, particles of calcium aluminum silicate powder 104 are optimized in size to produce the optimized core particles. The particles of calcium aluminum silicate powder 104 are the optimized core particles.

At step 210, the optimized core particles are inserted into the fluorine doped glass tube 106. Also, the fluorine doped glass tube 106 is filled compactly with the optimized core particles. In particular, the optimized core particles inside the fluorine doped glass tube 106 facilitates manufacturing of the optical fibre preform 100. Moreover, the fluorine doped glass tube 106 forms a cladding section.

At step 215, the optimized core particles are sintered inside the fluorine doped glass tube 106. In particular, sintering of the optimized core particles solidifies and adheres smoothly with the fluorine doped glass tube 106 for manufacturing of the optical fibre preform 100.

In accordance with an embodiment of the present invention, the fluorine doped glass tube 106 is sintered at a temperature in the range of about 1500 degree Celsius to 1600 degree Celsius. Alternatively, sintering temperature may vary.

In accordance with an embodiment of the present invention, sintering of the optimized core particles inside the fluorine doped glass tube 106 produces the optical fibre preform 100. In particular, the size of particles of the optimized core particles enables drawing of optical fibres with low transmission loss. The optimized core particles have high flow ability. In addition, the optimized core particles prevent sticking of particles to one another.

In accordance with an embodiment of the present invention, sintering of the optimized core particles produces optimum glassy core for the optical fibre preform 100. In addition, sintering of the optimized core particles solidifies and adheres smoothly with the fluorine doped glass tube 106 for manufacturing of the optical fibre preform 100. The optimized core particles enable the optical fibre preform 100 to draw the optical fibre with low attenuation. The optimized core particles produces the optical fibre preform 100 to draw low transmission loss optical fibre.

At step 220, the optical fibre is drawn by pulling the optical fibre preform 100.

In accordance with an embodiment of the present invention, the optical fibre preform 100 is manufactured by adopting a method. The method includes but may not be limited to powder-in-cylinder technique. In powder-in-cylinder technique, the optical fibre preform 100 is manufactured by inserting the optimized core particles in the fluorine doped glass tube 106.

In another embodiment of the present invention, the optical fibre preform 100 is utilized to draw the optical fibres directly using powder-in-cylinder technique.

In another embodiment of the present invention, the optical fibre preform 100 is stretched to form a plurality of solid preform rods having small diameter. Further, the plurality of solid preform rods is drawn to yield optical fibres.

It may be noted that the method 200 is explained to have above stated process steps, however, those skilled in the art would appreciate that the method 200 may have more/less number of process steps which may enable all the above stated embodiments of the present invention.

The present invention for optical fibre preform and method of manufacturing thereof to draw a low loss optical fibre with reduced manufacturing cost. In addition, the optimized core particles enable the optical fibre preform to produce the optical fibre with low attenuation.

The foregoing descriptions of pre-defined embodiments of the present technology have been presented for purposes of illustration and description. They are not intended to be exhaustive or to limit the present technology to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology.

What is claimed for:

1. A method for manufacturing of an optical fibre preform using an optimized core particles comprising steps of:
optimization of particles of calcium aluminum silicate powder, wherein the optimization of the particles of calcium aluminum silicate powder facilitates formation of the optimized core particles;
utilizing the optimized core particles, wherein the optimized core particles are filled inside a fluorine doped glass tube, wherein the optimized core particles inside the fluorine doped glass tube facilitates manufacturing of the optical fibre preform;
sintering the optimized core particles inside the fluorine doped glass tube, wherein sintering solidifies the optimized core particles and adheres smoothly with the fluorine doped glass tube for manufacturing of the optical fibre preform; and
drawing an optical fibre, wherein the optical fibre is drawn by pulling the optical fibre preform.

2. The method as claimed in claim 1, wherein the particles of calcium aluminum silicate powder forms a core section of the optical fibre preform.

3. The method as claimed in claim 1, wherein the fluorine doped glass tube forms a cladding section of the optical fibre preform.

4. The method as claimed in claim 1, wherein the optimized core particles has size in a range of about 30 microns to 50 microns.

5. The method as claimed in claim 1, wherein the core section is characterized by low attenuation of about 0.1 decibel per kilometer.

6. The method as claimed in claim 1, wherein the optical fibre preform is manufactured by a powder-in-cylinder technique.

7. The method as claimed in claim 1, wherein the powder-in-cylinder technique facilitates the optical fibre preform to form a plurality of solid preform rods of small diameter.

8. The method as claimed in claim 1, wherein sintering of the fluorine doped glass tube with the optimized core particles is performed at a temperature in range of about 1500 degree Celsius to 1600 degree Celsius.

9. The method as claimed in claim 1, wherein the optimized core particles enables drawing of the optical fibre from the optical fibre preform with low transmission loss.

10. The method as claimed in claim 1, wherein the fluorine doped glass tube has low viscosity.

11. An optical fibre preform using optimized core particles comprising:
a core section defined along a longitudinal axis; and a cladding section circumferentially surrounding the core section.

12. The optical fibre preform as claimed in claim 11, wherein the core section is formed by particles of calcium aluminum silicate powder.

13. The optical fibre preform as claimed in claim 11, wherein the cladding section is formed by a fluorine doped glass tube.

14. The optical fibre preform as claimed in claim 11, wherein a refractive index of the core section is greater than the refractive index of cladding section.

15. The optical fibre preform as claimed in claim 12, wherein the particles of calcium aluminum silicate powder are optimized to facilitate formation of the optimized core particles.

16. The optical fibre preform as claimed in claim 15, wherein size of the optimized core particles is in the range of about 30 microns to 50 microns.

17. The optical fibre preform as claimed in claim 15, wherein the optimized core particles is performed at a temperature in range of about 1500 degree Celsius to 1600 degree Celsius.

18. The optical fibre preform as claimed in claim 11, wherein the core section is characterized by low attenuation of about 0.1 decibel per kilometer.

19. The optical fibre preform as claimed in claim 11, wherein the optical fibre preform is manufactured by using powder-in-cylinder technique.

20. The optical fibre preform as claimed in claim 19, wherein the powder-in-cylinder technique facilitates the optical fibre preform to form a plurality of solid preform rods of small diameter.
